(19) United States
(12) Patent Application Publication
(10) Pub. No.: US 2026/0150773 A1
(43) Pub. Date: Jun. 4, 2026

(54) CONTROLLING MACHINE SPEED WHILE PERFORMING SECTION CONTROL

(71) Applicant: Deere & Company, Moline, IL (US)

(72) Inventors: Manpreet SINGH, Newton, IA (US); Michael A. TORZEWSKI, Waukee, IA (US); Ajit K. THANKAPPAN PILLAI, West Des Moines, IA (US); Ryan C. BURNLEY, Ankeny, IA (US)

(21) Appl. No.: 18/965,182

(22) Filed: Dec. 2, 2024

(51) Int. Cl. A01B 69/04

(52) U.S. Cl. CPC A01B 69/008

(57) ABSTRACT

A speed control system is configured to control a propulsion system of a mobile agricultural machine to ramp from a first ground speed to a second ground speed based upon a location of a boundary crossing point. The speed control system generates an effective boundary crossing point location based on the location of the boundary crossing point and a system delay between when a section control signal is generated and when a corresponding section control function is performed. A section control system generates section control signals based upon the effective boundary crossing point location.

### FIELD OF THE DESCRIPTION

The present descriptions relate to mobile agricultural machines. More specifically, the present description relates to mobile agricultural machines configured with section control and cruise control.

### BACKGROUND

There are many different types of mobile agricultural machines. Some such machines are self-propelled machines, such as self-propelled harvesters, self-propelled sprayers, and other self-propelled agricultural machines. Other mobile agricultural machines have a propulsion vehicle that provides propulsion to an implement. For instance, a tractor may be a propulsion vehicle that tows a planting implement. There are wide variety of other mobile agricultural machines that are either self-propelled mobile agricultural machines or mobile agricultural machines that include a propulsion vehicle and an implement.

A section control system is used to automatically turn machine or implement sections on or off. For instance, as an implement approaches a boundary or a portion of a field that has already been covered, a section control system can be used to turn off certain sections of the implement to avoid covering that portion of the field again.

By way of example, assume that a tractor is pulling a planting implement that uses section control. Assume further that, as the tractor pulls the planting implement, one section of the planting implement is approaching a portion of the field that has already been planted. In that case, a section control system can be used to turn off the planting functionality of that particular section of the planting implement so there is no overlap in planting. The section control system can be used on a wide variety of other agricultural implements, such as sprayers, other application implements, etc.

A cruise control system allows an operator (a manual operator or an automated or semi-automated operator) to input a speed control setting indicative of a speed at which the operator wishes the mobile agricultural machine to travel. The cruise control system then controls the propulsion system of the mobile agricultural machine to maintain the ground speed of the mobile agricultural implement based on the speed control setting.

Some mobile agricultural machines also include a smart cruise control system. The smart cruise control system can be used to provide location-based speed control. For instance, one speed control setting may be provided to control the ground speed of the mobile agricultural machine at a first location, such as when the mobile agricultural machine traverses the field. A second speed control setting may be provided to control the ground speed of the mobile agricultural machine at a second location, such as when the mobile agricultural machine navigates a turn (e.g., a headland turn, a turn at a non-possible boundary, etc.). The smart cruise control system then accesses the location of the mobile agricultural machine (such as from a location sensor) and controls the propulsion system of the mobile agricultural machine based on the location.

By way of example, if the mobile agricultural machine is traversing the field, then the cruise control system controls the propulsion system to maintain a ground speed based on the first speed control setting. As the mobile agricultural machine approaches a turn, the cruise control system controls the propulsion system of the mobile agricultural machine to ramp down (decelerate) to a ground speed based on the second speed control setting. After the turn, as the mobile agricultural machine exits the headlands and re-enters the field, the cruise control system can control the propulsion system to ramp back up (accelerate) to the ground speed based on the first speed control setting.

The discussion above is merely provided for general background information and is not intended to be used as an aid in determining the scope of the claimed subject matter.

### SUMMARY

A speed control system is configured to control a propulsion system of a mobile agricultural machine to ramp from a first ground speed to a second ground speed based upon a location of a boundary crossing point. The speed control system generates an effective boundary crossing point location based on the location of the boundary crossing point and a system delay between when a section control signal is generated and when a corresponding section control function is performed. A section control system generates section control signals based upon the effective boundary crossing point location.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a pictorial illustration showing one example of an agricultural system with a mobile agricultural machine approaching a boundary crossing point.

FIG. 2 is a pictorial illustration showing one example of an agricultural system with a mobile agricultural machine exiting a turn and angled boundary.

FIG. 3 is a pictorial illustration showing one example of an agricultural system with a mobile agricultural machine entering a turn proximate an angled boundary.

FIG. 4 is a pictorial illustration showing one example of an agricultural system with a mobile agricultural machine exiting a turn proximate and angled boundary.

FIG. 5 is a pictorial illustration showing one example of an agricultural system with a mobile agricultural machine traversing a field between two boundary crossing points that are spaced closely proximate one another.

FIG. 6 is a block diagram showing one example of an implement control system.

FIG. 7 is a flow diagram illustrating one example of the operation of an implement control system.

FIG. 8 is a flow diagram illustrating one example of the operation of a section control system.

FIG. 9 is a block diagram showing one example of an agricultural system with an implement control system fully or partially deployed in a remote server environment.

FIGS. 10, 11, and 12 show examples of mobile devices that can be used in the systems shown in other FIGS.

FIG. 13 is a block diagram showing one example of a computing environment that can be used in the architectures or systems shown in other figs.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

As discussed above, some mobile agricultural machines include a smart cruise control system and a section control system. The section control system generates section control signals that automatically turn sections of functionality on the machine or implement on or off. However, there is a system delay between the time when a section control signal is generated and sent to control a section on the machine or implement and when the section actually responds to that signal by performing the section control function commanded by the control signal. The system delay may include several different delay components. For instance, the system delay can include transmission delay, mechanical delay, electrical delay, and/or other delay components. There may be different system delays when controlling a function to turn on and when controlling the function to turn off. These two different types of delays are referred to herein as system delay ON and system delay OFF, respectively.

To accommodate for the system delay, the section control system looks into the future to anticipate when the section functionality should be turned on or off. This is known as lookahead functionality. The look ahead functionality identifies a position where the implement should be when the section control signal is issued so the section control command will be physically executed at the proper time, accounting for the system delay. To identify a lookahead position, the section control system uses the current ground speed of the implement, the system delay ON (the delay between a time when a control signal is generated to turn implement functionality on and when that functionality actually turns on), and/or system delay OFF (the delay between a time when a control signal commands implement functionality to turn off and when that functionality actually turns off).

For instance, a section control OFF signal may be issued to turn implement functionality off as the implement enters the headlands. A section control ON signal may be issued to turn the implement functionality back on as the implement comes out of the headlands and re-enters the field. The section control OFF signal should be issued before the implement reaches the headlands to accommodate for the system delay OFF. The section control ON signal should be issued before the implement re-enters the field to accommodate for the system delay ON. The section control system identifies the lookahead positions as the position where the implement should be when the section control OFF signal is generated and the position where the implement should be when the section control ON signal is generated. The section control system determines where to issue the section control signals based upon the system delay and assuming a constant speed of the implement.

However, the implement does not always travel at a constant speed, especially as the implement approaches a turn and exits a turn. Instead, assuming that the turn speed is slower than the field speed, then the automatic cruise control system will decelerate the implement as the implement approaches a headland boundary to enter the headlands and will accelerate the implement as the implement exits the headlands. Thus, if section control processing is performed during this acceleration or deceleration, this can result in gaps or overlaps. For instance, if the section control system assumes a constant speed and generates a section control OFF signal during deceleration (as the implement approaches the headland boundary), then the section control operation will be executed before the implement reaches the desired point (e.g., the section will be turned off before the implement reaches the headlands), resulting in a gap. If the section control system assumes a constant speed and issues a section control ON signal during acceleration (as the implement exits the headlands, then the section control operation will be executed after the implement reaches the desired point (e.g., the implement functionality will be turned on after the implement crosses the headland boundary and has reentered the field) also resulting in a gap.

Thus, the present description describes an implement control system that modifies the point at which the smart cruise control system changes the speed of the implement. The modification is made to ensure that the implement is traveling at a constant speed during section control processing. For instance, the implement control system can ensure that the implement has already ramped down to the turn speed before the section control OFF signal is issued as the implement approaches a headland boundary. Also, the implement control system can ensure that the implement stays at the turn speed until the section control ON signal is issued and the section control ON command is executed (e.g., the section actually turns on), before ramping up to the field speed. This enhances the operation of the implement by reducing coverage gaps and overlaps. As used herein, in one example, a boundary crossing point is a geographic location where a section control function is to be performed (e.g., section control ON function or a section control OFF function). Thus, a boundary crossing point may be a headland (or other bounded area) entry point where the implement crosses a headland (or other bounded area) boundary on the way into the headlands (or other bounded area), and a boundary crossing point may also be a headland (or other bounded area) exit point where the implement crosses the headland (or other bounded area) boundary when exiting the headlands (or other bounded area).

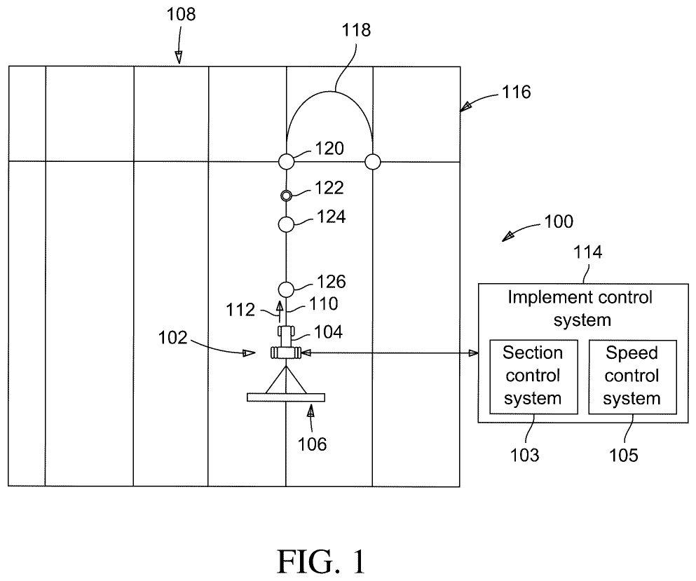

FIG. 1 shows one example of an agricultural system 100 in which a mobile agricultural machine 102 includes a propulsion vehicle (such as a tractor) 104 and an implement (such as a planter) 106. FIG. 1 shows that mobile agricultural machine 102 is traversing field 108 along a guidance line 110 generally in the direction indicated by arrow 112. FIG. 1 also shows that mobile agricultural machine 102 can include, or communicate with, an implement control system 114. In the example shown in FIG. 1, implement control system 114 (which is described in greater detail below with respect to other FIGs.) includes a section control system 103 and a speed control system 105. Section control system 103 can control sections and/or functionality on implement 106 independently of one another. Speed control system 105 can perform location-based cruise control so the ground speed of mobile agricultural machine 102 can be controlled according to a plurality of different speed set points based on the location of mobile agricultural machine 102.

For example, field 108 may include a headland portion 116. Therefore, if implement 106 is a planter, the section control system 103 on implement control system 114 can be used to turn the sections or planting functionality on implement 106 off as mobile agricultural machine 102 enters headlands 116 to make a headland turn indicated by turn line 118. Similarly, section control system 103 can turn the sections or planting functionality of implement 106 back on as implement 106 exits headlands 116 and re-enters the field after completing turn 118. To generate the section control signals, section control system 103 detects a current speed of mobile agricultural machine 102 and accesses the system delay corresponding to the section control signal (e.g., the system delay ON or system delay OFF). Speed control system 105 also identifies the headland entry point 120. Then, based upon the current location of mobile agricultural machine 102, the current speed of mobile agricultural machine 102, the system delay, section control system 103 identifies a location where the section control signal must be issued in order to have the section control operation executed at the appropriate point in field 108.

In the example shown in FIG. 1, assume that mobile agricultural machine 102 is traveling in the direction indicated by arrow 112. Assume also that the headland entry point (the boundary crossing point where implement 106 enters the headlands 116) is identified as the geographic location indicated by point 120. Then, section control system 103 looks ahead to determine whether the headland entry point 120 is within a look-ahead window. If so, section control system 103 determines how far ahead of headland entry point 120 the section control OFF signal needs to be issued for the section control OFF operation to be executed at headland entry point 120.

At the same time, speed control system 105 is looking forward to identify the location of headland entry point 120 to calculate the location in field 108 where speed control system 105 should begin ramping the ground speed of mobile agricultural machine 102 down from the field speed to the turn speed. In FIG. 1, given the desired ramp down rate, assume that speed control system 105 determines that the ground speed should be ramped down between points 124 and 120. That distance is referred to as the ramp down distance. The rate at which the ground speed is ramped up or down will affect the ramp up/down distance and may be set based on a default setting, based on an operator preference, or in other ways. Given the rate at which the speed is to be ramped down from the field speed to the turn speed, speed control system 105 thus identifies a location in field 108 where that deceleration should begin (point 124), so the ground speed is at the turn speed by the time implement 106 reaches the location of headland entry point 120.

As discussed above, this can lead to problems. Assume, for the sake of the present discussion, that when mobile agricultural machine 102 reaches point 124, section control system 103 determines that the headland entry point 120 is within its look-ahead window. Section control system 103 then begins section control processing. Section control system 103 determines that, given the current speed of mobile agricultural machine 102 at point 124 and the system delay OFF, section control system 103 should issue the section control OFF signal at point 122 in field 108. Assume further that speed control system 105 determines that the ground speed of mobile agricultural machine 102 should be decelerated from the field speed to the turn speed beginning at point 124. This means that the section control system 103 will have calculated the point 122 where the section control OFF signal is issued, incorrectly. Section control system 103 will have assumed that the ground speed of mobile agricultural machine 102 will remain constant and be the same at point 120 that it is when section control system 103 began processing (e.g., the speed at point 120 will be the same as it was at point 124). In reality, however, the ground speed of mobile agricultural machine 102 will have decelerated starting at point 124 until it reaches the turn speed at point 120. This will result in the functionality of implement 106 being turned off prematurely, before implement 106 reaches point 120, because machine 102 will be traveling slower than the section control system expected between points 124 and 120.

Therefore, in accordance with one example, speed control system 105 uses the system delay OFF value to move the turn start point 120 to an effective turn start point 124. This will ensure that, by the time section control system 103 sees that turn start point 120 is within its look-ahead window and begins performing section control processing, mobile agricultural machine 102 (at least implement 106) will be traveling at a constant speed and will continue traveling at that constant speed during the entire time that section control system 103 identifies when to issue the section control OFF command and when that command is executed. That is, implement 106 will be traveling at a constant speed between points 124 and 120, because it will already have ramped down to the turn speed between points 126 and 124.

More specifically, speed control system 105 calculates an offset value that at least corresponds to the look-ahead window in section control system 103 and applies that offset value to headland entry point 120 to obtain an effective headland entry point 124. Speed control system 105 then uses the effective headland entry point 124 to perform speed control and accommodate the ramp down distance. Therefore, speed control system 105 controls the ground speed of mobile agricultural machine 102 to begin decelerating to the turn speed earlier (at point 126) so the speed of mobile agricultural machine 102 remains constant for the entire look-ahead window of section control system 103 (e.g., the speed remains constant between points 124 and 120). Mobile agricultural machine 102 will thus have reached the turn speed by point 124. Only then will the headland entry point 120 be within the look-ahead window of section control system 103. Section control system 103 will perform section control processing during the time that implement 106 is between points 124 (the effective headland entry point) and point 120 (the actual headland entry point). This means that implement 106 will be traveling at a constant rate of speed during the entire time that section control system 103 is performing section control processing so the point 122 at which the section control command is issued is calculated correctly.

In order to calculate the offset value, speed control system 105 accesses the section control ON delay and uses that value to calculate a distance offset (the distance between points 120 and 124.). That distance offset is then applied to the headland entry point 120 to obtain the effective headland entry point 124. Speed control system 105 uses the effective headland entry point 124 to calculate when to ramp down the ground speed of mobile agricultural machine 102 from the field speed to the turn speed. Thus, speed control system begins ramping down the ground speed of mobile agricultural machine 102 at point 126 to reach the turn speed by the time mobile agricultural machine 102 reaches the effective headland entry point 124.

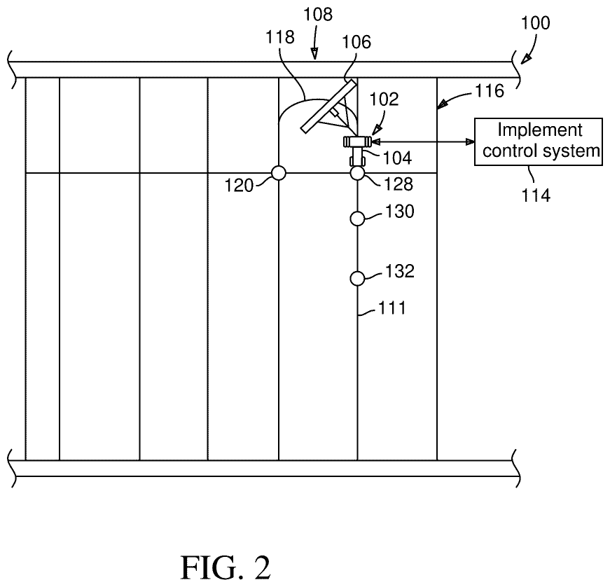

FIG. 2 also shows an example of agricultural system 100. Some items in FIG. 2 are similar to those shown in FIG. 1, and they are similarly numbered. FIG. 2 shows that mobile agricultural machine 102 has now nearly completed turn 118 to begin to follow guidance line 111 through field 108. When mobile agricultural machine 102 reaches turn endpoint 128, speed control system 105 would normally begin ramping up the speed of mobile agricultural machine 102 from the turn speed to the field speed. Similarly, section control system 103 would look forward to determine whether headland exit point 128 is within the look-ahead window of section control system 103. If so, then section control system 103 will determine when to issue the section control ON signal so that the section control functionality will be on by the time implement 106 reaches headland exit point 128.

A similar problem will result as that described above with respect to FIG. 1. Section control system 103 will assume a constant ground speed when calculating when to issue the section control ON signal. By contrast, propulsion vehicle 104 will begin accelerating so that the ground speed of mobile agricultural machine 102 is ramped up from the turn speed to the field speed so the speed will not be constant.

Therefore, in order to address this issue, speed control system 105 accesses the system delay ON value based upon that value, calculates a distance offset. The distance offset is applied to the headland exit point 128 in order to identify an effective headland exit point 130. Speed control system 105 will use the effective headland exit point 130 in determining when to begin accelerating the ground speed of mobile agricultural machine 102 from the turn speed to the field speed, instead of using headland exit point 128. Therefore, mobile agricultural machine 102 will maintain a constant speed (the turn speed) all the way through turn 118 and until mobile agricultural machine 102 reaches the effective headland exit point 130. At point 130, speed control system 105 will begin accelerating mobile agricultural machine 102 from the turn speed to the field speed. The acceleration will take place over a ramp up distance that is based on how quickly the ramp up is to occur. In FIG. 2, the ramp up distance is the distance between points 130 and 132.

Because speed control system 105 uses the effective headland exit 130 instead of the actual turn endpoint 128, section control system 103 can identify when the actual headland exit point 128 is within its look-ahead window and calculate when to issue the section control ON command and have that command actually executed, all while mobile agricultural machine 102 is at a constant speed. Once that section control command is executed, only then will propulsion vehicle 104 begin accelerating.

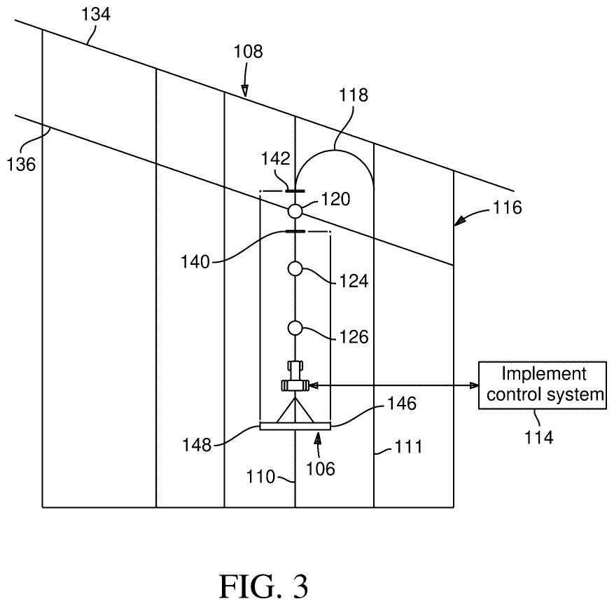

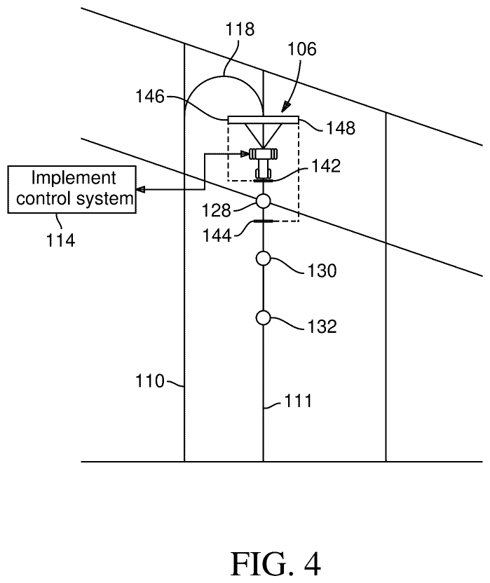

FIGS. 3 and 4 are similar to FIGS. 1 and 2, and similar items are similarly numbered. However, in FIGS. 3 and 4, field 108 has an angled boundary 134 that is disposed at a non-right angle relative to the guidance lines 110 and 111. Therefore, the boundary 136 of headland 116 is also at an angle relative to the guidance lines 110 and 111. Section control signals will thus be issued at different times to control sections across the transverse and longitudinal axis of implement 106. For instance, in FIG. 3, section control will begin at point 140 and will continue through point 142 as the entire width of implement 106 crosses the angled boundary 136 of headland 116. Similarly, after completing turn 118 (as shown in FIG. 4) section control will begin at point 142 and continue until point 144 as mobile agricultural machine 102 travels along guidance line 111. This is because side 146 of implement 106 will encounter the boundary of headland 116 before side 148 encounters the boundary of headland 116. Therefore, in the example shown in FIGS. 3 and 4, an additional offset (represented by the distance between points 120 and 142 in FIG. 3 and the distance between points 143 and 128 in FIG. 4) is included in the offset value that is applied to the turn start point 120 (in FIG. 3) and the headland exit point 128 (in FIG. 4).

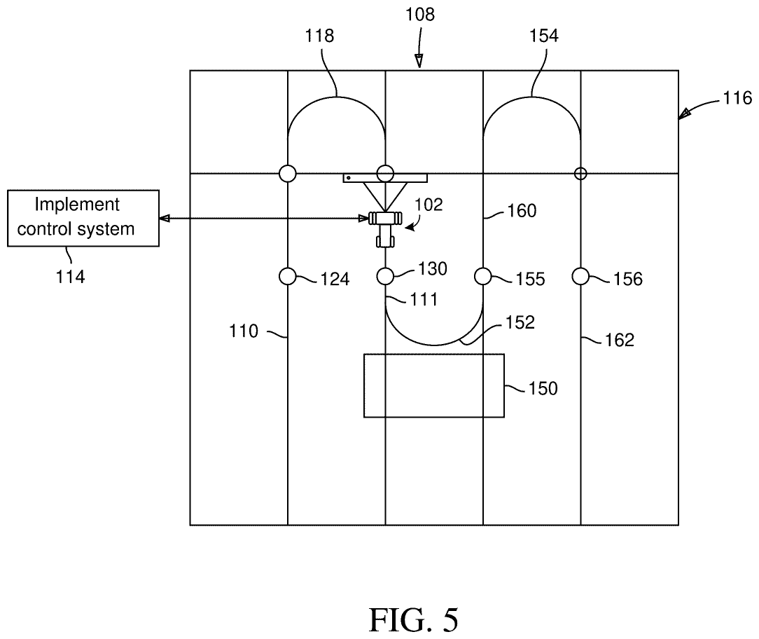

FIG. 5 is similar to FIGS. 1 and 2 and similar items are similarly numbered. However, FIG. 5 shows that field 108 has an internal un-passable area 150. FIG. 5 shows that mobile agricultural machine 102 will first travel along guidance line 110, make the headland turn 118 and begin traveling along guidance line 111. Mobile agricultural machine 102 will then make turn 152 to avoid crossing the boundary of unpassable area 150 and begin traveling along guidance line 160. There is an effective turn zone in which mobile agricultural machine 102 must make turn 152 so that no part of mobile agricultural machine 102 crosses into un-passable area 150. The effective turn zone may be defined by the dimensions of mobile agricultural machine or in other ways. After making turn 152 and traveling along guidance line 160, mobile agricultural machine 102 will then make headland turn 154 and begin traveling along guidance line 162. FIG. 5 also shows that speed control system 105 will have calculated the effective boundary crossing points 124 and 155 for turns 118 and 154, respectively, and the effective boundary crossing points 130 and 156 four turns 118 and 154, respectively. The effective boundary crossing points 130 and 155 are points on a boundary line that defines the effective turn zone corresponding to un-passable area 150.

FIG. 5 shows that the boundaries of the internal unpassable area 150 are so close to the boundary of field 108 and headland 116 that mobile agricultural machine 102 is not capable of ramping up to the field speed between turn 118 and turn 152. Therefore, in the example shown in FIG. 5, speed control system 105 determines that the turns are so close to one another that there is insufficient distance to perform ramp up and ramp down between the turns. Speed control system 105 thus maintains the ground speed of mobile agricultural machine 102 at the turn speed beginning at effective boundary crossing point 124 of turn 118 and continuing until mobile agricultural machine 102 reaches the effective boundary crossing point 156 of turn 154, at which point speed control system 105 can ramp up the ground speed of mobile agricultural machine 102 to the field speed.

It will also be noted that the discussions above with respect to guidance lines 110, 111, 160, 162, etc shows straight guidance lines. However, the guidance lines need not be straight. The present discussion equally applies to scenarios where the guidance lines are curved or configured in other ways.

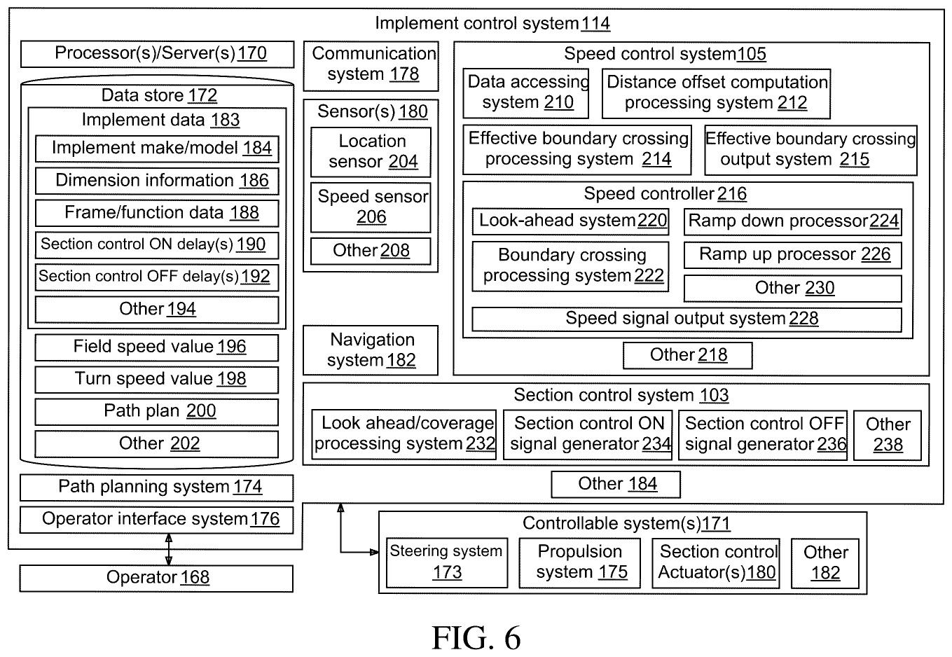

FIG. 6 is a block diagram showing one example of implement control system 114 in more detail. FIG. 6 shows that, in one example, an operator 168 can interact with implement control system 114. Operator 168 may be a human operator, an automated operator, or a semi-automated operator.

FIG. 6 also shows that, in one example, implement control system 114 can generate outputs to control one or more controllable systems 171. Controllable systems 171 can include such things as a steering system 173 on propulsion vehicle 104, a propulsion system 175 on propulsion vehicle 104, section control actuators 180 on implement 106, and/or any of a wide variety of other items 182.

FIG. 6 shows that implement control system 114 can include one or more processors 170, data store 172, path planning system 174, operator interface system 176, communication system 178, sensors 180, navigation system 182, speed control system 105, section control system 103, and other functionality 184. Data store 172 can store implement data 183 which can include implement make/model 184, dimension information 186, frame/function data 188, section control ON delays 190, section control OFF delays 192, and other items 194. Data store 172 can also include one or more field speed values 196, one or more turn speed values 198, a path plan 200, and other items 202. Sensors 180 can include location sensor 204, speed sensor 206, and/or other sensors 208. Speed control system 105 can include data accessing system 210, distance offset computation processing system 212, effective boundary crossing shift processing system 214, effective boundary crossing output system 215, speed controller 216, and other items 218. Speed controller 216 can include look-ahead system 220, boundary crossing processing system 222, ramp down processor 224, ramp up processor 226, speed signal output system 228, and other items 230. Speed control system 103 can include look-ahead/coverage processing system 232, section control ON signal generator 234, section control OFF signal generator 236, and other items 238. Before describing the overall operation of implement control system 114, a description of some of the items in implement control system 114, and their operation, will first be provided.

Implement make/model data 184 identifies the make and/or model of mobile agricultural machine 102, such as the make and/or model of propulsion vehicle 104, the make and/or model of implement 106, etc. Dimension information 186 identifies the dimensions of implement 106 and/or the dimensions of propulsion vehicle 104. Frame/function data 188 identifies the configuration of the frame of implement 106 as well as the functions that can be executed by implement 106. Frame/function data 188 may identify different sections that can be individually controlled with section control system 103, and/or implement functions that can be individually controlled by section control system 103. Section control ON delays 190 identify the system delays between when one or more different section control ON signals are issued by section control system 103 and when those commands are executed on implement 106. Section control OFF delays 192 identify system delays between when section control OFF signals are issued by section control system 103 and when those commands are executed on implement 106. Field speed value 196 identifies a target speed or field speed setting that is used to control the ground speed of mobile agricultural machine 102 as machine 102 traverses field 108. Turn speed value 198 identifies a target speed or turn speed setting that is used to control the ground speed of mobile agricultural machine 102 as machine 102 executes a turn. Path plan 200 is a path plan that defines the route of mobile agricultural machine 102 through field 108.

Path planning system 174 generates a path plan 200 for mobile agricultural machine 102 to follow as mobile agricultural machine 102 travels through field 108. Navigation system 182 can be used to automatically or semi-automatically navigate mobile agricultural machine 102 along the route indicated by the path plan. In another example, navigation system 182 may generate an output for operator 168 using operator interface system 176 indicative of the route that mobile agricultural machine 102 should follow, given the path plan 200. In one example, path planning system 174 can use any of a variety of different types of path planning algorithms, such as the A*algorithm, the D*algorithm, the Dijkstra algorithm, an algorithm used to explore random trees, genetic algorithms, etc. Navigation system 182 can incorporate guidance, navigation, and control to automatically navigate mobile agricultural machine 102, or to perform semi-automated navigation, or to generate an output to assist in manual navigation.

Communication system 178 facilitates the communication of the items of implement control system 114 with one another and may also facilitate communication over a network to a remote server environment, to a farm manager system, to other machines, etc. Therefore, communication system 178 may be any of a variety of systems, such as a wide area network communication system, a local area network communication system, a Bluetooth or Wi-Fi communication system, a near field communication system, a cellular communication system, and/or any of a wide variety of other communication systems or combinations of systems.

Location sensor 204 generates an output indicative of the location of sensor 204 in a global or local coordinate system. Therefore, location sensor 204 can be a global navigation satellite system (GNSS) receiver, a cellular triangulation system, a dead reckoning system, or any of a variety of other location sensors. Speed sensor 206 generates an output indicative of a ground speed of implement 106. Speed sensor 206 may generate an output indicative of the ground speed of different portions of implement 106 (e.g., when implement 106 is executing a turn, the outer edge of implement 106 will have a higher ground speed than the inner edge), and/or other outputs. Speed sensor 206 may thus be a sensor that senses the speed of rotation of wheels on propulsion vehicle 104, the speed of a transmission or engine output on propulsion vehicle 104, a radar sensor or other sensor that can be used to generate an output indicative of ground speed, or another sensor. Similarly, speed sensor 206 may generate an output based upon an input from another sensor. For instance, speed sensor 206 may receive multiple inputs from location sensor 204 and generate an output indicative of the ground speed of mobile agricultural machine 102 based upon the change in position of machine 102 over time.

In speed control system 105, data accessing system 210 can access data from data store 172, from a remote server environment, and/or from other data stores. Thus, data accessing system 210 can access the path plan 200, the field speed value 196, the turn speed value 198, the section control ON delays 190, the section control OFF delays 192, and/or other data from data store 172.

Distance offset computation processing system 212 generates one or more distance offset values that will be applied to the boundary crossing points identified in path plan 200. Thus, distance offset computation processing system 212 can generate a distance offset that is sufficient to move the effective boundary crossing point outside of the look-ahead window for section control system 103. That is, distance offset computation processing system 212 can generate a distance offset that will move the effective boundary crossing point to a position that will accommodate the ramp up or ramp down of mobile agricultural machine 102 so that mobile agricultural machine 102 will be at a constant speed during section control processing.

Effective boundary crossing shift processing system 214 applies the distance offset output by distance offset computation processing system 212 to a boundary crossing point (to a headland entry point and/or to a headland exit point) to identify the effective boundary crossing point (e.g., the effective headland entry point and/or the effective headland exit point). Effective boundary crossing point output system 215 generates an output to speed controller 216 indicative of the effective boundary crossing points so that speed controller 216 can perform the ramp up and ramp down operations based on the effective boundary crossing points, instead of based on the actual boundary crossing points.

Speed controller 216 generates control signals to control the ground speed of mobile agricultural machine 102 based on the field speed value 196, as mobile agricultural machine 102 is traveling through the field, and based upon the turn speed value 198, as mobile agricultural machine 102 is making a turn. Look-ahead system 220 performs a look-ahead operation, examining the route of mobile agricultural machine 102 ahead of the current position of mobile agricultural machine 102 to determine whether mobile agricultural machine 102 is approaching an effective boundary crossing point. Thus, look-ahead system 220 may look ahead along the route by a predetermined distance or a variable distance (which may vary based upon the ground speed of mobile agricultural machine 102 or in other ways), to identify whether a boundary crossing point is within that look-ahead distance. Look-ahead system 220 looks for the effective headland entry points and the effective headland exit points instead of the actual headland entry points and the actual headland exit points. Boundary crossing processing system 222 determines whether a detected boundary crossing point is an effective headland entry point or an effective headland exit point. Ramp down processor 224 determines when to begin ramping down the ground speed of mobile agricultural machine 102 when an effective headland entry point is identified. Ramp up processor 226 determines when to begin ramping up the ground speed of mobile agricultural machine 102 when an effective headland exit point is identified. Speed signal output system 228 generates a control signal that can be used to control propulsion system 175 to propel mobile agricultural machine 102 at the desired speed (ramp down/up to the turn speed or the field speed) based upon an output from ramp down processor 224 or ramp up processor 226.

Section control system 103 performs section control for implement 106 by looking ahead along the route of mobile agricultural machine 102 to determine whether implement 106 will encounter any features for which section control should be performed. Look-ahead/coverage processing system 232 looks ahead of mobile agricultural machine 102 along its route to determine whether any sections of implement 106 will need to be controlled. For instance, if one section of implement 106 is about to encounter a portion of the field that has already been covered, then look-ahead/coverage processing system 232 can generate an output indicating that that section should be turned off as soon as the section encounters the portion of the field that has already been covered. Similarly, if look-ahead/coverage processing system 232 determines that implement 106 is about to cross a headland boundary, then look-ahead/coverage processing system 232 can generate an output indicating that the functionality of implement 106 should be turned off as soon implement 106 reaches the headland boundary.

Section control ON signal generator 234 accesses section control ON delays 190 to determine how far ahead of the field feature a section control ON signal should be generated, and generates the section control ON signal at the appropriate time. Section control OFF signal generator 236 accesses section control OFF delays 192 and determines when a section control OFF signal should be generated. Again, as discussed above, section control system 103 assumes that the ground speed of mobile agricultural machine 102 will remain constant during the section control processing (e.g., during the lookahead to identify field features indicative of upcoming section control, while determining when a section control ON or section control OFF signal should be generated, the generation of those signals, and the actual execution of the operation commanded by those signals).

Steering system 173 can include mechanisms for steering steerable wheels on propulsion vehicle 104, for performing skid steer operations, for steering tracks, or another system. Propulsion system 175 can include an internal combustion engine along with a transmission, hydraulic motors, individual drive motors, or other mechanisms that provide propulsion of mobile agricultural machine 102. Section control actuators 180 can include hydraulic cylinders, electric or pneumatic actuators, and/or any of a wide variety of other actuators that can be used to turn functionality of implement 106 on and off, to raise and lower or otherwise configure sections of implement 106, and/or to control different sections of implement 106 in other ways.

Operator interface system 176 illustratively includes operator interface mechanisms that can be used to generate outputs for operator 168 and receive inputs from operator 168. Therefore, operator interface system 176 can generate displays, sounds, haptic outputs, and/or any other audio, visual, or haptic outputs for providing information to operator 168. The operator interface mechanisms can include a display screen, a touch sensitive display screen, a speaker, a microphone, a point-and-click device, steering wheel, levers, pedals, joysticks, linkages, or other mechanisms. Where an interface is provided on a display screen, the interface can include user input mechanisms such as icons, links, buttons, or other mechanisms that can be actuated using a point-and-click device, using voice commands, using touch gestures, etc.

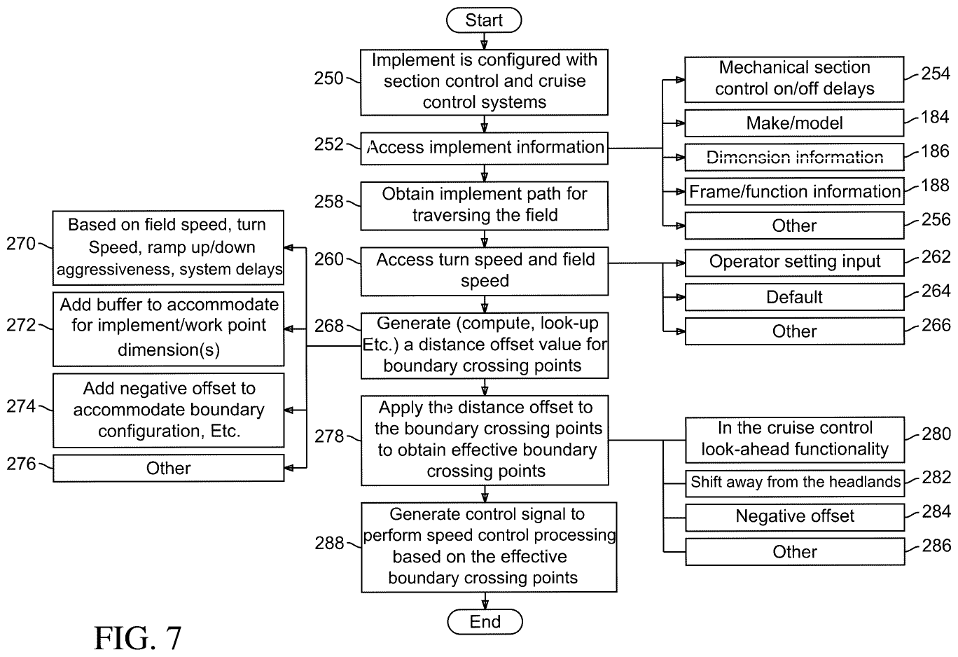

FIG. 7 is a flow diagram illustrating one example of the operation of implement control system 114 in generating effective boundary crossing points so that section control processing can be performed while mobile agricultural machine 102 is running at a constant ground speed. It is first assumed that the implement is configured with both section control (e.g., section control system 103), and cruise control (e.g., speed control system 105) as indicated by block 250 in the flow diagram of FIG. 7.

Data accessing system 210 then accesses implement information 183 from data store 172 or elsewhere, as indicated by block 252. The implement information can include section control ON/OFF delays 190 and 192, as indicated by block 254 and the flow diagram of FIG. 7. The implement information can include the make/model information 184, the dimension information 186, the frame/function information 188, and/or any of a wide variety of other information 256.

Distance offset computation processing system 212 obtains the path or route of implement 106 (e.g., from path plan 200 or elsewhere), for traversing the field, as indicated by block 258. The path or route may identify the location of the headlands 116. Distance offset computation processing system 212 then accesses the turn speed value 198 and field speed value 196 as indicated by block 260. It will be noted that the turn speed value 198 and field speed value 196 may be received through an operator setting input 262, as a default value 264, or in another way 266.

By knowing the section control ON and section control OFF delays 190, 192, respectively, distance offset computation processing system 212 can determine the look-ahead window used by section control system 103 in performing section control processing. Therefore, distance offset computation processing system 212 generates (e.g., computes or looks up) one or more distance offset values for the headland entry points and headland exit points on the route or path plan 200 of implement 106. Generating one or more distance offset values is indicated by block 268 in the flow diagram of FIG. 7.

For example, based upon the field speed value and the turn speed value, distance offset computation processing system 212 can determine the magnitude of the speed change that needs to take place when ramping the ground speed of implement 106 down from the field speed to the turn speed and when ramping the ground speed of the implement 106 up from the turn speed to the field speed. Further, by knowing the aggressiveness with which the ramp up and ramp down is to take place, distance offset computation processing system 212 can determine the distance that implement 106 will travel when the ground speed of implement 106 is ramped up or down. Therefore, based upon the field speed, the turn speed, the ramp up/down aggressiveness, and the system delays, distance offset computation processing system 212 can compute one or more distance offset values by which the headland entry points and headland exit points are to be moved to obtain the effective headland entry points and the effective headland exit points. Computing the distance offset value(s) helps to ensure that implement 106 will be traveling at a constant speed during section control processing. Generating the distance offset value(s) for the headland entry points and headland exit points using the field speed, the turn speed, the ramp up/down aggressiveness, and the system delays is indicated by block 270 in the flow diagram of FIG. 7.

In addition, the distance offset computation processing system 212 can add a buffer distance value to the offset to accommodate for a number of different variables. The buffer distance may, for instance, accommodate for the dimensions of the various work points on implement 106 (e.g., the distance that implement 106 is towed behind propulsion vehicle 104, etc.), or other variables. Adding a buffer to accommodate for implement work point dimensions is indicated by block 272 in the flow diagram of FIG. 7.

Further, where the field and headland boundary configuration is at an angle with respect to the guidance lines that mobile agricultural machine 102 is following, then a negative offset value can be added to the distance offset (such as the negative offset values described above with respect to FIGS. 3 and 4) as indicated by block 274 in the flow diagram of FIG. 7.

As one example, the distance offset value that can be applied to a headland entry point (e.g. to the point where mobile agricultural machine 102 is entering headlands 116) may be calculated as follows:

$$Dist . Offset from Headland = turn speed ( m / s ) * ( max section control OFF delay ( s ) + buffer ( s ) ) \qquad Eq . 1$$

Where;
Dist. Offset from Headland is the offset distance that the headland entry point is to be adjusted away from the turn or headland to obtain the effective headland entry point;
turn speed is the turn speed value 198 in m/s;
max section control OFF delay is the maximum section control OFF delay 192 for all sections or functions on implement 106 in s; and
buffer is a buffer time in s.

Also, in one example, the distance offset value to be applied to the headland exit point may be calculated as follows:

$$Dist . Offset from Headland = turn speed ( m / s ) * ( max section control ON delay ( s ) + buffer ( s ) ) \qquad Eq . 2$$

Where;
Dist. Offset from Headland is the offset distance that the headland exit point is to be adjusted away from the turn or headland to obtain the effective headland exit point;
turn speed is the turn speed value 198 in m/s;
max section control ON delay is the maximum section control ON delay 190 for all sections or functions on implement 106 in s; and
buffer is a buffer time in s.

The distance offset value(s) for the headland entry point(s) and headland exit point(s) can be generated in other ways as well, as indicated by block 276.

Effective boundary crossing shift processing system 214 then applies the distance offset value(s) generated by system 212 to the headland entry point(s) and the headland exit point(s) to obtain effective headland entry points and effective headland exit points as indicated by block 278. Effective boundary crossing output system 215 can generate an output of the effective boundary crossing points to speed controller 216 for use in determining when to begin ramping up and ramping down, as indicated by block 280.

As mentioned above, in one example, the computed distance offset(s) shift the effective headland exit point and the effective headland entry point away from the turn or headland, as indicated by block 282. In another example, a negative offset (described above with respect to FIGS. 3 and 4) can be added as indicated by block 284. The distance offset values can be applied to the headland entry point(s) and headland exit point(s) in other ways as well, as indicated by block 286.

Speed controller 216 then uses the effective headland entry points and the effective headland exit points in generating control signals to perform speed control. Generating control signals based upon the effective boundary crossing points is indicated by block 288 in the flow diagram of FIG. 7.

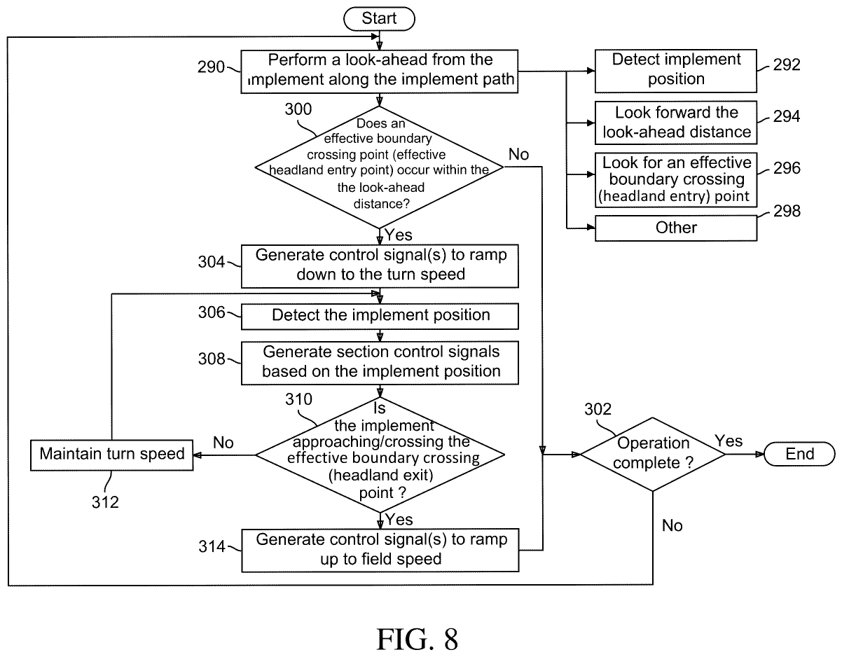

FIG. 8 is a flow diagram illustrating one example of performing speed control and section control, incorporating the effective headland entry points and effective headland exit points. It is assumed for the sake of the description of FIG. 8 that mobile agricultural machine 102 is traveling through field 108 in a direction toward a headland 116. For instance, it is assumed that mobile agricultural machine 102 is in the position illustrated in FIG. 1 in which mobile agricultural machine 102 is traveling at the field speed setting through field 108 in the direction indicated by arrow 112 toward the boundary of headland 116. It is also assumed for the sake of description of FIG. 8 that speed control system 105 has already detected the headland entry points and headland exit points on the route of implement 106 and calculated the effective headland entry points and the effective headland exit points. It will be appreciated, however, that the effective headland entry points and the effective headland exit points could be calculated as mobile agricultural machine 102 is traversing the field, during run time, but it is assumed for the sake of the present description that the effective headland entry points and effective headland exit points have already been calculated.

As mobile agricultural machine 102 moves in the direction indicated by arrow 112, look-ahead system 220 in speed controller 216 performs a look-ahead from implement 106, along the implement path or route indicated by path plan 200, or indicated by another route indicator. Performing a look-ahead is indicated by block 290 in the flow diagram of FIG. 8. In one example, look-ahead system 220 first detects the current position of implement 106, as indicated by block 292. That position may be obtained using location sensor 204 and dimension information 186 or in other ways. Look-ahead system 220 looks ahead along the route by a look-ahead distance which may be a default distance, a dynamically changing distance which changes based upon implement location or implement ground speed, or another look-ahead distance. Looking forward along the implement route by the look-ahead distance is indicated by block 294 in the flow diagram of FIG. 8. Boundary crossing processing system 222 looks for an effective headland entry point that is within the look-ahead distance ahead of implement 106 along its route. Looking for an effective headland entry point is indicated by block 296 in the flow diagram of FIG. 8. Performing a look-ahead from the implement along the implement route can be performed in other ways as well, as indicated by block 298.

If, at block 300, turn start/end processing system 222 does not identify an effective headland entry point within the look-ahead distance, then processing moves to block 302 where look-ahead system 220 continues to perform look-ahead operations until the agricultural operation being performed by mobile agricultural machine 102 is completed.

If, at block 300, look-ahead system 220 performs a look-ahead and turn start/end processing system 222 determines that an effective headland entry point does occur within the look-ahead distance, then ramp down processor 224 generates control signals to ramp the ground speed of machine 102 down from the field speed to the turn speed, as indicated by block 304.

Section control system 103 can also perform section control during the operation of mobile agricultural machine 102. For instance, look-ahead/coverage processing system 232 detects the position of implement 106 and generates section control signals based upon the implement position and based upon detected field features (such as headland boundaries, areas of the field that have already been covered, etc.). Detecting the implement position for performing section control is indicated by block 306, and generating section control signals to control the section control actuators 180 based upon the implement position is indicated by block 308.

It will be noted that, even after speed controller 216 has ramped the ground speed of implement 106 down from the field speed to the turn speed, speed controller 216 continues to maintain the ground speed of mobile agricultural machine 102 at the turn speed so that mobile agricultural machine 102 is at a constant speed during section control processing. Thus, look-ahead system 220 examines the route ahead of mobile agricultural machine 102 to determine whether mobile agricultural machine 102 is approaching an effective headland exit point. If the implement 106 has not crossed the effective headland exit point, then this means that speed controller 216 is still controlling mobile agricultural machine 102 at the turn speed. Detecting whether the implement and/or other portion of mobile agricultural machine 102 is approaching or is crossing an effective headland exit point is indicated by block 310. Maintaining the ground speed of mobile agricultural machine 102 at the turn speed, if it has not crossed an effective headland exit point, is indicated by block 312. Processing then reverts to block 306 where section control system 102 continues to generate section control signals.

If, at block 310 it is determined that implement 106 has crossed an effective headland exit point, then this means that all of the section control processing will have been completed so that speed controller 216 can ramp the ground speed of mobile agricultural machine 102 up to the field speed. Generating control signals to ramp up to the field speed is indicated by block 314 and the flow diagram of FIG. 8.

Until the agricultural operation being performed by mobile agricultural machine 102 is complete, as determined at block 302, processing reverts to block 290 where the look-ahead system 220 in speed controller 216 continues to perform a look-ahead operation to determine whether machine 102 is approaching a headland boundary.

It can thus be seen that the present description describes a system that modifies the location of headland entry points and headland exit points to obtain effective headland entry points and effective headland exit points. A cruise control system or speed controller then performs speed control operations based upon the effective headland entry points and effective headland exit points. The effective headland entry points and effective headland exit points are offset from the actual headland entry points and headland exit points in a direction away from the turn or headlands to help to ensure that mobile agricultural machine 102 will be operating at a constant ground speed during section control processing (e.g., while a section control system performs a look-ahead and generates section control signals to execute section control operations). This increases the accuracy of the section control operations, thus reducing gaps and overlaps.

It will also be noted that the present discussion has described a mobile agricultural machine 102 with a towed implement 106. This is for the sake of example only. The present discussion can just as easily be made with respect to a mobile agricultural machine such as a self-propelled sprayer where the implement (spray boom) is a front mounted boom or a rear mounted boom, or where the mobile agricultural machine is a tractor with a front mounted implement or a rear mounted implement, or to other mobile agricultural machines that have section control and cruise control functionality.

The present discussion has mentioned processors and servers. In one example, the processors and servers include computer processors with associated memory and timing circuitry, not separately shown. The processors or servers are functional parts of the systems or devices to which they belong and are activated by and facilitate the functionality of the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays the mechanisms has speech recognition components, the mechanisms can be actuated using speech commands.

A number of data stores have also been discussed. It will be noted the data stores can each be broken into multiple data stores. All can be local to the systems accessing the data stores, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will be noted that the above discussion has described a variety of different systems, components, generators, and/or logic. It will be appreciated that such systems, components, generators, and/or logic can be comprised of hardware items (such as processors and associated memory, or other processing components, some of which are described below) that perform the functions associated with those systems, components, generators, and/or logic. In addition, the systems, components, generators, and/or logic can be comprised of software that is loaded into a memory and is subsequently executed by a processor or server, or other computing component, as described below. The systems, components, generators, and/or logic can also be comprised of different combinations of hardware, software, firmware, etc., some examples of which are described below. These are only some examples of different structures that can be used to form the systems, components, generators, and/or logic described above. Other structures can be used as well.

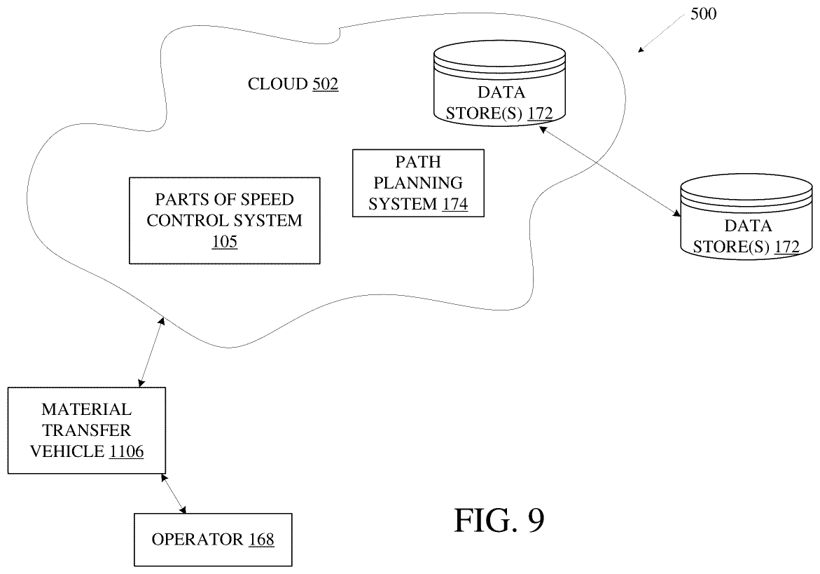

FIG. 9 is a block diagram of agricultural system 100, shown in FIG. 1, except that it communicates with elements in a remote server architecture 500. In an example, remote server architecture 500 can provide computation, software, data access, and storage services that do not require end-user knowledge of the physical location or configuration of the system that delivers the services. In various examples, remote servers can deliver services over a wide area network, such as the internet, using appropriate protocols. For instance, remote servers can deliver applications over a wide area network, and they can be accessed through a web browser or any other computing component. Software or components shown in previous FIGS. as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, the components and functions can be provided from a conventional server, or they can be installed on client devices directly, or in other ways.

In the example shown in FIG. 9, some items are similar to those shown in previous FIGS. and they are similarly numbered. FIG. 9 specifically shows that portions of speed control system 105, path planning system 174, and data store 172 (and/or other system) can be located at a remote server location 502. Therefore, mobile agricultural machine 102 accesses those systems through remote server location 502.

FIG. 9 also depicts another example of a remote server architecture. FIG. 9 shows that it is also contemplated that some elements of previous FIGS are disposed at remote server location 502 while others are not. By way of example, data store 172, parts of speed control system 105, and/or other items can be disposed at a location separate from location 502 and accessed through the remote server at location 502. Regardless of where the items are located, they can be accessed directly by mobile agricultural machine 102, through a network (either a wide area network or a local area network), the items can be hosted at a remote site by a service, or the items can be provided as a service, or accessed by a connection service that resides in a remote location. Also, the data can be stored in substantially any location and intermittently accessed by, or forwarded to, interested parties. All of these architectures are contemplated herein.

It will also be noted that the elements of previous FIGS., or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

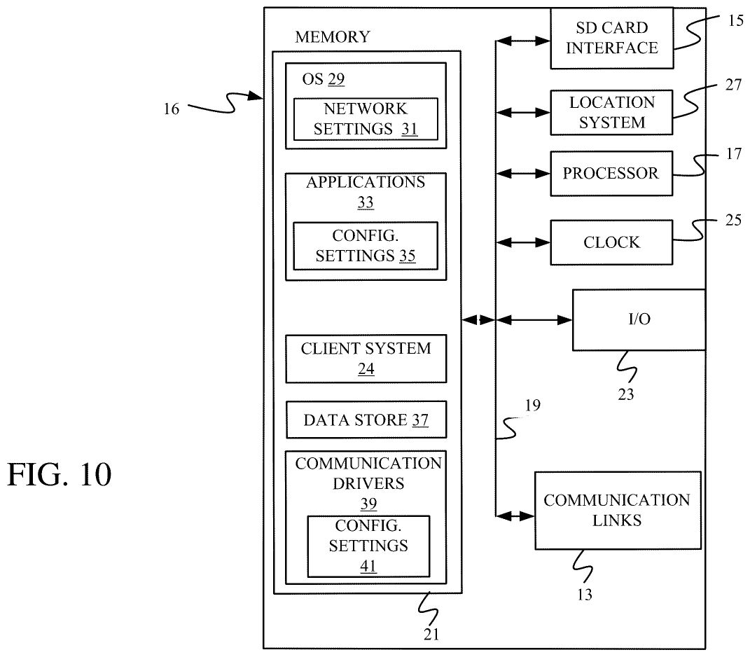

FIG. 10 is a simplified block diagram of one illustrative example of a handheld or mobile computing device that can be used as a user's or client's handheld device 16, in which the present system (or parts of it) can be deployed. For instance, a mobile device can be deployed in the operator compartment of mobile agricultural machine 102 for use in generating, processing, or displaying the speed and/or section control data. FIGS. 10-12 are examples of handheld or mobile devices.

FIG. 10 provides a general block diagram of the components of a client device 16 that can run some components shown in previous FIGS., that interact with them, or both. In device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from previous FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

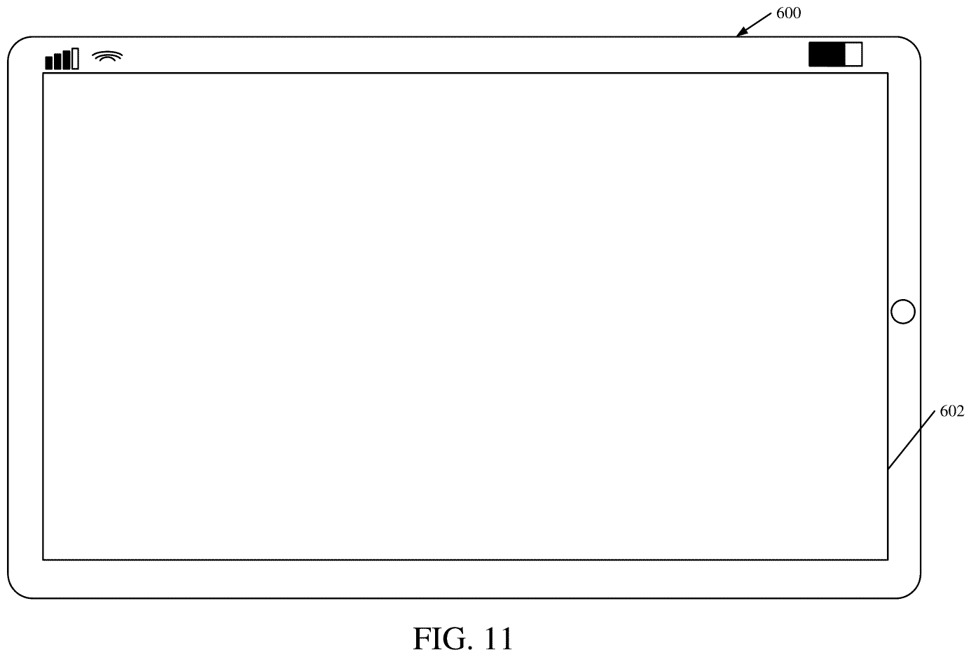

FIG. 11 shows one example in which device 16 is a tablet computer 600. In FIG. 11, computer 600 is shown with user interface display screen 602. Screen 602 can be a touch screen or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice input as well.

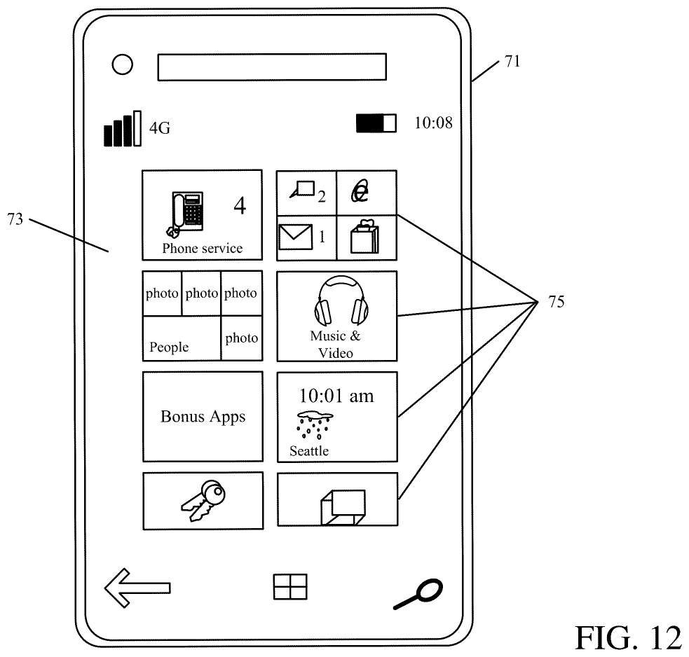

FIG. 12 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

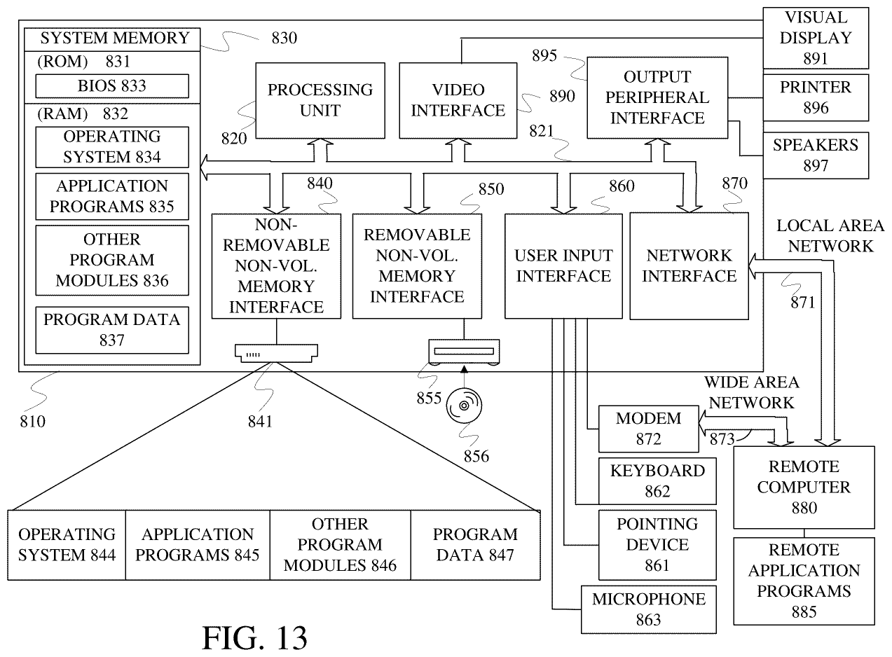

FIG. 13 is one example of a computing environment in which elements of previous FIGS., or parts of it, (for example) can be deployed. With reference to FIG. 13, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to previous FIGS. can be deployed in corresponding portions of FIG. 13.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computer 810. Communication media May embody computer readable instructions, data structures, program modules or other data in a transport mechanism and includes any information delivery media. The term “modulated data signal” means a signal that has one or more of its characteristics set or changed in such a manner as to encode information in the signal.

System memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 13 illustrates operating system 834, application programs 835, other program modules 836, and program data 837.

The computer 810 may also include other removable/non-removable volatile/nonvolatile computer storage media. By way of example only, FIG. 13 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 13, provide storage of computer readable instructions, data structures, program modules and other data for the computer 810. In FIG. 13, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network-CAN, local area network-LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 13 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method, comprising:
identifying a location of a boundary crossing point, corresponding to a boundary, for a mobile agricultural machine;
modifying the location of the boundary crossing point, based on a section control system delay corresponding to the mobile agricultural machine, to obtain a location of an effective boundary crossing point;
automatically controlling a ground speed of the mobile agricultural machine based on the location of the effective boundary crossing point; and
automatically performing a section control operation of the mobile agricultural machine based on the location of the boundary crossing point.

2. The computer implemented method of claim 1 wherein modifying the location of the boundary crossing point comprises:
computing an offset distance; and
applying the offset distance to the location of the boundary crossing point to obtain the location of the effective boundary crossing point.

3. The computer implemented method of claim 2 wherein applying the offset distance to the location of the boundary crossing point comprises:
applying the offset distance to increase a distance between the location of the effective boundary crossing point and a bounded area relative to a distance between the location of the boundary crossing point and the bounded area.

4. The computer implemented method of claim 3 wherein the mobile agricultural machine travels along a route and wherein automatically performing section control comprises:
determining whether the route ahead of the mobile agricultural machine, by a look-ahead distance, includes a field feature for which a section control operation is to be executed, wherein the look-ahead distance is based on a system delay in performing section control.

5. The computer implemented method of claim 4 wherein computing the distance offset comprises:
computing the offset distance so the distance between the location of the effective boundary crossing point and the location of the boundary crossing point exceeds the look-ahead distance.

6. The computer implemented method of claim 2 wherein automatically controlling the ground speed comprises:
changing the ground speed of the mobile agricultural machine between a turn speed and a field speed, over a speed change distance, based on the effective boundary crossing point.

7. The computer implemented method of claim 6 wherein computing the offset distance comprises:
computing the offset distance to be at least as large as the speed change distance.

8. The computer implemented method of claim 6 wherein, as the mobile agricultural machine approaches a given boundary, changing the ground speed of the mobile agricultural machine between the field speed and the turn speed for the given boundary is performed before performing a section control operation for the given boundary.

9. The computer implemented method of claim 6 wherein, as the mobile agricultural machine exits a given boundary, changing the ground speed of the mobile agricultural machine between the turn speed and the field speed for the given boundary is performed after performing a section control operation for the given boundary.

10. A control system, comprising:
speed control system configured to identify a location of a boundary crossing point, corresponding to a bounded area, for a mobile agricultural machine and to modify the location of the boundary crossing point, based on a section control system delay corresponding to the mobile agricultural machine, to obtain a location of an effective boundary crossing point;
a speed controller configured to automatically control a ground speed of the mobile agricultural machine based on the location of the effective boundary crossing point; and
a section control system, configured to automatically perform a section control operation to control functionality of the mobile agricultural machine based on the location of the boundary crossing point.

11. The control system of claim 10 wherein the speed control system comprises:
a distance offset computation processing system configured to compute an offset distance; and
an effective boundary crossing shift processing system configured to apply the offset distance to the location of the boundary crossing point to obtain the location of the effective boundary crossing point.

12. The control system of claim 11 wherein the effective boundary crossing shift processing system is configured to apply the offset distance to increase a distance between the location of the effective boundary crossing point and the bounded area relative to a distance between the location of the boundary crossing point and the bounded area.

13. The control system of claim 12 wherein the mobile agricultural machine travels along a route and wherein the section control system comprises:
a look-ahead processing system configured to determine whether the route ahead of the mobile agricultural machine, by a look-ahead distance, includes a field feature for which a section control operation is to be executed, wherein the look-ahead distance is based on a system delay in performing section control.

14. The control system of claim 13 wherein the distance offset computation processing system is configured to compute the offset distance so the distance between the location of the effective boundary crossing point and the location of the boundary crossing point exceeds the look-ahead distance.

15. The control system of claim 11 wherein the speed controller is configured to modify the ground speed of the mobile agricultural machine between a turn speed and a field speed, over a speed change distance, based on the effective boundary crossing point.

16. The control system of claim 15 wherein the distance offset computation processing system is configured to compute the offset distance to be at least as large as the speed change distance.

17. The control system of claim 15 wherein, as the mobile agricultural machine approaches a given boundary crossing point, the speed controller is configured to change the ground speed of the mobile agricultural machine between the field speed and the turn speed for the given boundary crossing point before the section control system performs a section control operation for the given boundary crossing point.

18. The control system of claim 15 wherein, as the mobile agricultural machine exits a given bounded area, the speed controller is configured to change the ground speed of the mobile agricultural machine between the turn speed and the field speed for the given bounded area after the section control system performs a section control operation for the given bounded area.

19. A computing system, comprising:
at least one processor; and
a data store that stores computer executable instructions which, when executed by the at least one processor, cause the at least one processor to perform steps, comprising:
identifying a location of a boundary crossing point, corresponding to a bounded area, for a mobile agricultural machine;
modifying the location of the boundary crossing point, based on a section control system delay corresponding to the mobile agricultural machine, to obtain a location of an effective boundary crossing point;
automatically controlling a ground speed of the mobile agricultural machine based on the location of the effective boundary crossing point; and
automatically performing a section control operation of the mobile agricultural machine based on the location of the boundary crossing point.

20. The computing system of claim 19 wherein controlling the ground speed comprises controlling the mobile agricultural machine to travel at a first speed over the field, and changing the ground speed to control the mobile agricultural machine to travel at a second speed as the mobile agricultural machine traverses the bounded area, wherein modifying the location of the boundary crossing point comprises:
modifying the location of the boundary crossing point, to obtain the location of the effective boundary crossing point, so the ground speed is controlled to change from the first speed to the second speed before the mobile agricultural machine reaches the boundary crossing point.
